(19) United States
(12) Patent Application Publication
(10) Pub. No.: US 2026/0072628 A1
(43) Pub. Date: Mar. 12, 2026

(54) AUTOMATED MANAGEMENT OF PARALLEL PRINTING

(71) Applicant: Toshiba Tec Kabushiki Kaisha, Tokyo (JP)

(72) Inventors: Maziar M. BASTANI, Rancho Santa Margarita, CA (US); Farnaz SHAHVIR, Rancho Santa Margarita, CA (US)

(21) Appl. No.: 18/882,100

(22) Filed: Sep. 11, 2024

(51) Int. Cl. G06F 3/12; B41J 3/42; B41J 29/00; G03G 15/00

(52) U.S. Cl. CPC G06F 3/124; B41J 3/42; B41J 29/00; G03G 15/5016; G03G 15/5087; G06F 3/1215; G06F 3/126

(57) ABSTRACT

A image forming apparatus is configured to manage parallel printing of a print job, by performing the steps of: retrieving a request to print the print job; determining a network availability of one or more other image forming apparatuses connected to a network; generating a workplan for distributing the print job across a plurality of image forming apparatuses based on (1) print job information, including one or more of: the number of pages, the storage size, and a speed requirement assigned to the print job, and (2) image forming apparatus information, including one or more of: respective loads on, print speeds of, specific capabilities of, and failure rates of the plurality of image forming apparatuses; dividing, according to the workplan, the print job into a plurality of constituent print jobs; and transmitting one of the plurality of constituent print jobs to one of the plurality of image forming apparatuses.

### FIELD

Embodiments to be described herein generally relate to an image forming apparatus, a parallel printing management method for an image forming apparatus, and a non-transitory computer-readable medium for an image forming apparatus.

### BACKGROUND

In a variety of computing environments, people use image forming apparatuses for performing print jobs. For example, in workplaces, employees of organizations often use multi-function printers (MFPs), which are image forming apparatuses that are capable of performing several functions in addition to printing print jobs, such as scanning, copying, and faxing. The print jobs include content to be printed such as text documents and images, and include various print settings such as whether to print in color or only in black and white and whether to print in duplex or simplex. Some print jobs take a long time for any individual MFP to print, e.g., several minutes. For example, this may occur for print jobs that include several pages to print. A method is desired for completing such print jobs in a timelier manner.

### BRIEF DESCRIPTION OF THE DRAWINGS

FIG. 1 is a block diagram of a cloud environment and a user environment in which embodiments may be implemented.

FIG. 2 is a block diagram of an example of inputs and outputs of an artificial neural network that may be used for generating a workplan for parallel printing, according to some embodiments.

FIG. 3 is a flow diagram of a method that may be performed by an MFP to determine whether to perform parallel printing, according to some embodiments.

FIG. 4 is a flow diagram of a method that may be performed by an MFP to generate and manage a workplan for parallel printing, according to some embodiments.

### DETAILED DESCRIPTION

One or more embodiments provide an image forming apparatus connected to a network and configured to manage parallel printing of a print job. The image forming apparatus includes a processor that is programmed to perform the steps of: retrieving a request to print the print job; determining a network availability of one or more other image forming apparatuses connected to the network; generating a workplan for distributing the print job across a plurality of image forming apparatuses based on (1) print job information, including one or more of: the number of pages, the storage size, and a speed requirement assigned to the print job, and (2) image forming apparatus information, including one or more of: respective loads on, print speeds of, specific capabilities of, and failure rates of the plurality of image forming apparatuses; dividing, according to the workplan, the print job into a plurality of constituent print jobs, each of which is to be printed by one of the plurality of image forming apparatuses; and transmitting one of the plurality of constituent print jobs to one of the plurality of image forming apparatuses to be printed thereby. Hereinafter, embodiments will be described with reference to the drawings. In the drawings, the same reference symbols denote the same or similar portions.

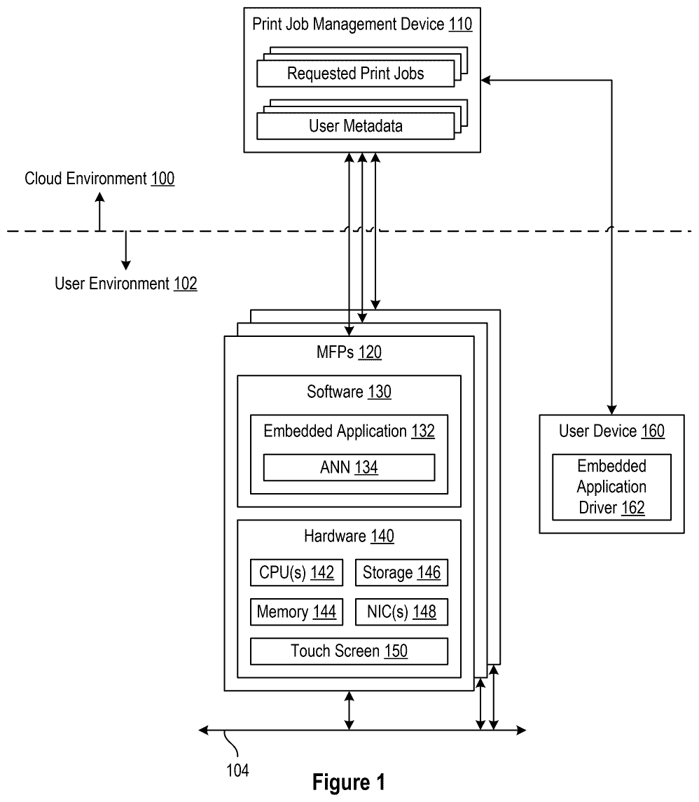

FIG. 1 is a block diagram of a cloud computing environment 100 and a user computing environment 102 in which embodiments may be implemented. For example, user environment 102 may be a workplace of a particular organization. Cloud environment 100 may be, e.g., a “public cloud,” including a public data center at which software is provisioned both for the organization of user environment 102 and for other organizations. In the example of FIG. 1, MFPs 120 access print jobs that are stored remotely in cloud environment 100, and that were requested by a user device 160 in user environment 102. It should be noted, however, that embodiments are not limited to such example. For example, MFPs 120 may simply receive documents directly from user device 160. Additionally, while embodiments are described with reference to MFPs, it should be appreciated that embodiments are applicable to other image forming apparatuses.

In the example of FIG. 1, cloud environment 100 includes a print job management device 110, which is, e.g., one or more server computers. Print job management device 110 includes requested print jobs and user metadata. The requested print jobs are print jobs that have been requested by user devices such as user device 160 in user environment 102. Each of the requested print jobs includes content to be printed such as text documents and images, and includes various print settings such as whether to print in color or only in black and white and whether to print in duplex or simplex. Each portion of the user metadata describes a user who requested a corresponding one of the requested print jobs. For example, each portion of the user metadata may include a user identifier or email address associated with a user of MFPs 120 who requested the corresponding print job.

User environment 102 includes MFPs 120 and user device 160. MFPs 120 are image forming apparatuses that are capable of performing several functions such as printing, scanning, copying, and faxing. Each of MFPs 120 is constructed on hardware 140. Hardware 140 includes components of MFPs, such as one or more central processing units (CPUs) 142, memory 144 such as random-access memory (RAM), storage 146 such as one or more magnetic drives or solid-state drives (SSDs), one or more network interface controllers (NICs) 148, and a touch screen 150. CPU(s) 142 are configured to execute instructions such as executable instructions that perform one or more operations described herein, which may be stored in memory 144.

NIC(s) 148 of each of MFPs 120 enable MFP 120 to communicate with print job management device 110, e.g., over a wide area network (WAN) (not shown), and with other devices of user environment 102, e.g., over a local area network (LAN) 104. Additionally, although not illustrated in FIG. 1, according to embodiments in which user device 160 transmits print jobs directly to MFPs 120, NIC(s) 148 enable MFP 120 to communicate with user device 160, e.g., over LAN 104. Touch screen 150 displays information to a user of MFPs 120, e.g., using a liquid crystal display (LCD). Touch screen 150 also includes a touch sensor (not shown) such as a capacitive touch sensor for detecting user inputs made by the user touching touch screen 150.

Hardware 140 supports software 130, including an embedded application 132. Embedded application 132 is a specialized software program designed to perform specific tasks for managing parallel printing. As used herein, “parallel printing” is distributing a single requested print job across a plurality of MFPs such that multiple MFPs print different portions of the same requested print job instead of a single MFP printing the entire print job. An instance of embedded application 132 executes on each of MFPs 120.

On each of MFPs 120, the tasks of embedded application 132 include, e.g., downloading requested print jobs from print job management device 110, determining when to use parallel printing, and generating workplans for parallel printing. A workplan specifies a plurality of constituent print jobs that an overall requested print job is to be split into. For example, a first constituent print job may include a first half of the overall print job, and a second constituent print job may include a second half of the overall print job. Such a workplan also specifies assignments of which of MFPs 120 are to print the respective constituent print jobs.

According to some embodiments, embedded application 132 includes an artificial neural network (ANN 134), which is a machine-learning model consisting of interconnected layers of nodes, referred to as “neurons. ” A “neuron” is a fundamental unit or component of an ANN. Neurons in an ANN work together to process input data, transform it through layers of computation, and produce an output. ANN 134 may be trained, e.g., for determining whether to use parallel printing and, if so, for generating a workplan therefor.

User device 160 is a computer such as a desktop computer, laptop computer, tablet computer, or smartphone. User device 160 is used by a user of MFPs 120, e.g., to upload print jobs to print job management device 110, e.g., over a WAN, to be printed by one of MFPs 120. After uploading a print job, the user may approach one of MFPs 120 and instruct it to download the print job from print job management device 110 for printing. The user may instruct such downloading and printing by touching touch screen 150 to interact with a user interface (UI) thereof.

User device 160 may include an embedded application driver 162, which enables user device 160 to communicate with print job management device 110. As mentioned previously, according to some embodiments, user device 160 may transmit print jobs directly to MFPs 120. According to such embodiments, user device 160 may not include embedded application driver 162. Additionally, according to such embodiments, software 130 may receive print jobs without downloading them from print job management device 110, and may then perform functionality described herein with respect to embedded application 132.

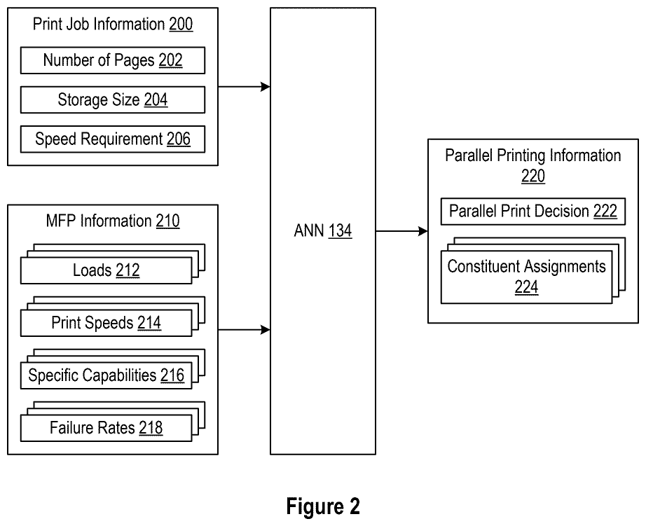

FIG. 2 is a block diagram of an example of inputs and outputs of ANN 134 of one of MFPs 120, according to some embodiments. In the example of FIG. 2, ANN 134 has input neurons (not shown), which takes as inputs, information from two groups: print job information 200 and MFP information 210. As used herein, “print job information” is information about a requested print job, and “MFP information” is information about MFPs that are available for possibly performing constituent print jobs. Any non-numerical values of print job information 200 and MFP information 210 may be converted to numerical values before being input into ANN 134. In the example of FIG. 2, ANN 134 also has outputs neurons (not shown), which output parallel printing information 220.

Print job information 200 includes, e.g., a number of pages 202 of a requested print job, a storage size 204 of the print job, and a speed requirement 206 of the print job. Number of pages 202 is a value expressing the size of the print job in total pages. Storage size 204 is a value expressing the storage space required for storing the print job, e.g., in megabytes. Speed requirement 206 is a value expressing how quickly the print job has been requested to be printed, e.g., in minutes or as a priority level such as high priority, normal priority, or low priority.

MFP information 210 includes, e.g., loads 212, print speeds 214, specific capabilities 216, and failure rates 218. Each of loads 212, each of print speeds 214, each of specific capabilities 216, and each of failure rates 218 corresponds to one of MFPs 120. Each of loads 212 is a value expressing a busyness of a corresponding MFP, e.g., in terms of how many pages of documents or images are already queued up for printing thereby. Each of print speeds 214 is a value expressing how fast a corresponding MFP is capable of printing, e.g., in pages per minute. Each of specific capabilities 216 is a value expressing whether a corresponding MFP has a predetermined capability such as printing in color, duplex printing, or stapling pages. Each of failure rates 218 is a value expressing a reliability of the model of a corresponding MFP when performing print jobs, e.g., as a known historical failure rate, which may be expressed as a percentage for example.

Parallel printing information 220 includes, e.g., a parallel printing decision 222 and constituent assignments 224. Parallel printing decision 222 is a value expressing whether to use parallel printing for a requested print job, i.e., whether to divide the print job into a plurality of constituent print jobs. For example, parallel printing decision 222 may be a binary value. Constituent assignments 224 are values expressing how to generate a workplan (indicating a specific workplan) for execute parallel printing (if it is determined to use parallel printing). Each of constituent assignments 224 may correspond to one of MFPs 120. For example, each of constituent assignments 224 may express a total number of pages for a corresponding MFP to print and/or specify which page numbers of a print job for the corresponding MFP to print.

ANN 134 includes a plurality of weights and biases (not shown). The weights are numerical values associated with connections between neurons of ANN 134, and the biases are numerical values added to outputs of neurons. During operation, when print job information 200 and MFP information 210 are input into ANN 134, ANN 134 performs operations in and between layers thereof based on print job information 200 and MFP information 210 to generate outputs indicating parallel printing information 220. ANN 134 performs the operations based on its weights and biases, e.g., multiplying values by weights between layers and adding values to biases and performing activation functions in the layers.

It should be noted that according to some embodiments, ANN 134 may not be used for determining whether to use parallel printing and for determining how to generate a workplan. According to such embodiments, similar inputs to those included in FIG. 2 may be used for making such determinations according to an algorithm. Such algorithm may generate similar outputs to those included in FIG. 2 based on such inputs. Regardless of whether ANN 134 is used for making such determinations, outputs such as those of parallel printing information 220 may be optimized for printing an overall print job based on inputs such as those of print job information 200 and MFP information 210.

For example, it may be determined to use parallel printing (and to generate a workplan) based on one or more of: number of pages 202 being greater than a threshold, storage size 204 being greater than a threshold, and speed requirement 206 being greater than a threshold. Parallel printing in such situations may greatly reduce the time required for printing large print jobs that could otherwise take, e.g., several minutes for a single one of MFPs 120 to print. Conversely, it may be determined not to use parallel printing based on any of number of pages 202, storage size 204, and speed requirement 206 being less than a threshold. Parallel printing in such situations may not be as useful because it may not take much time for one of MFPs 120 to print the requested print job, e.g., only a few seconds.

A workplan may be generated in which a requested print job is divided evenly among a plurality of MFPs 120 in terms of pages. On the other hand, a workload may be distributed unevenly, e.g., based on different values of loads 212, print speeds 214, specific capabilities 216, and failure rates 218. For example, ANN 134 may assign a larger constituent print job to one of MFPs 120 having a smaller load and a smaller constituent print job to another of MFPs 120 having a larger load, as indicated by different values within loads 212. Such assignments may reduce the time for printing the overall requested print job by assigning more printing to MFPs 120 that are available to begin printing respective constituent print jobs sooner.

As another example, ANN 134 may assign a larger constituent print job to one of MFPs 120 having a higher print speed and a smaller constituent print job to another of MFPs 120 having a lower print speed, as indicated by different values within print speeds 214. Such assignments may reduce the time for printing the overall requested print job by assigning more printing to those of MFPs 120 that print faster. As another example, ANN 134 may assign a constituent print job including a specific requirement such as printing in color, duplex printing, or stapling, to one of MFPs 120 with a specific capability for performing the specific requirement. ANN 134 may then assign a constituent print job that does not include the specific requirement to another of MFPs 120 that does not have the specific capability.

As another example, ANN 134 may assign constituent print jobs to a plurality of MFPs 120 that each has a failure rate less than or equal to a threshold, and may determine not to assign any constituent print job to one of MFPs 120 that has a failure rate greater than the threshold. Accordingly, ANN 134 may determine not include one of MFPs 120 with a high failure rate even if embedded application 132 is connected thereto. Such assignment may improve the reliability of printing the overall requested print job by avoiding those of MFPs 120 that are likely to fail. It should be noted that when ANN 134 assigns constituent print jobs to a plurality of MFPs 120, ANN 134 may determine not to include the one of MFPs 120 on which ANN 134 executes.

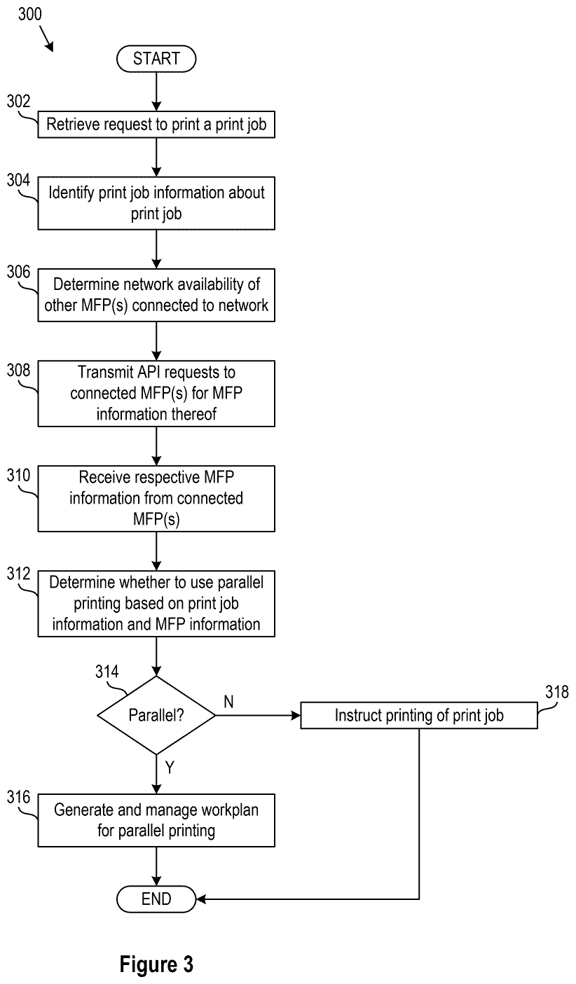

FIG. 3 is a flow diagram of a method 300 that may be performed by one of MFPs 120 to determine whether to perform parallel printing, according to some embodiments. Steps of method 300 will be discussed as being performed by embedded application 132 of one of MFPs 120 that a user approaches after uploading a print job to print job management device 110. However, embodiments are not limited as such, and some of the steps may be performed by other components. For example, to trigger method 300, the user may login to an account associated with print job management device 110, e.g., by entering a username and password or scanning an identification card via touch screen 150.

At step 302, embedded application 132 retrieves a request to print the print job. For example, embedded application 132 may download the requested print job from print job management device 110. Print job management device 110 may identify the correct print job based on user metadata therein and information provided by embedded application 132 such as a username. At step 304, embedded application 132 identifies print job information 200 about the requested print job, e.g., one or more of number of pages 202, storage size 204, and speed requirement 206.

At step 306, embedded application 132 determines the network availability of one or more of other MFPs 120 connected to a network such as LAN 104. For example, embedded application 132 may transmit Simple Network Management Protocol (SNMP) messages to others of MFPs 120 and make such determination based on SNMP responses to the messages. At step 308, embedded application 132 transmits application programming interface (API) requests to any connected ones of MFPs 120 for MFP information 210 thereof (for the subset of MFP information 210 corresponding thereto).

At step 310, embedded application 132 receives respective MFP information 210 from the connected one(s) of MFPs 120. For example, for each of connected MFPs 120, respective MFP information 210 may include one of loads 212, one of print speeds 214, one of specific capabilities 216, and one of failure rates 218. At step 312, embedded application 132 determines whether to use parallel printing based on print job information 200 and MFP information 210. As discussed above in conjunction with FIG. 2, embedded application 132 may use ANN 134 for generating parallel printing information 220, indicating whether to use parallel printing as parallel printing decision 222. At step 314, if embedded application 132 determines to use parallel printing, method 300 moves to step 316.

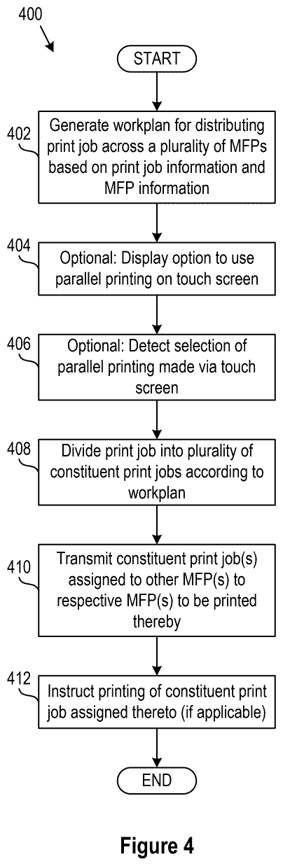

At step 316, embedded application 132 generates and manages a workplan for parallel printing the requested print job, as discussed further below in conjunction with FIG. 4. After step 316, method 300 ends. Returning to step 314, if embedded application 132 determines not to use parallel printing, method 300 moves to step 318. At step 318, embedded application 132 instructs the one of MFPs 120 in which embedded application 132 executes to print the entire print job, in response to which MFP 120 prints the print job. After step 318, method 300 ends.

FIG. 4 is a flow diagram of a method 400 that may be performed by one of MFPs 120 to generate and manage a workplan for parallel printing, according to some embodiments. Steps of method 400 will be discussed as being performed by embedded application 132 of one of MFPs 120 that a user approaches after uploading a print job to print job management device 110. However, embodiments are not limited as such, and some of the steps may be performed by other components. At step 402, embedded application 132 generates a workplan for distributing a requested print job across a plurality of MFPs 120 based on print job information 200 and MFP information 210. As discussed above in conjunction with FIG. 2, embedded application 132 may use ANN 134 for generating parallel printing information 220, indicating the workplan via constituent assignments 224.

It should also be noted that ANN 134 may generate parallel print decision 222 and constituent assignments 224 as a single set of outputs. In other words, step 402 of FIG. 4 and step 312 of FIG. 3 may be performed concurrently. At step 404, as an optional step, embedded application 132 may display on touch screen 150, an option to use parallel printing. At step 406, as another optional step, embedded application 132 may detect a selection (acceptance) of using parallel printing made by the user by touching touch screen 150. It should be noted that instead of presenting a parallel printing option to the user, embedded application 132 may automatically determine to execute the workplan and skip steps 404 and 406.

At step 408, embedded application 132 divides the requested print job into a plurality of constituent print jobs according to the workplan. At step 410, embedded application 132 transmits any constituent print jobs assigned to others of MFPs 120 to the respective MFPs to be printed thereby, in response to which the respective MFPs print the respective constituent print jobs. At step 412, if applicable, embedded application 132 instructs the one of MFPs 120 in which embedded application 132 executes to print a constituent print job assigned thereto, in response to which MFP 120 prints the constituent print job. After step 412, method 400 ends.

The embodiments described herein may relate to one or more computer programs or as one or more computer program modules embodied in computer-readable storage media. The term computer-readable medium refers to any data storage device that can store data, which can thereafter be input into an apparatus or computer system. Computer-readable media may be based on any existing or subsequently developed technology that embodies computer programs in a manner that enables a computer to read the programs. Examples of computer-readable media include magnetic drives, SSDs, network-attached storage (NAS) systems, RAM, read-only memory (ROM), compact disks (CDs), digital versatile disks (DVDs), and other optical and non-optical data storage devices. A computer-readable medium can also be distributed over a network-coupled computer system so that computer-readable code is stored and executed in a distributed fashion.

While certain embodiments have been described, these embodiments have been presented by way of example only, and are not intended to limit the scope of the invention. Indeed, the novel embodiments described herein may be embodied in a variety of other forms. Furthermore, various omissions, substitutions, and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus connected to a network and configured to manage parallel printing of a print job, said image forming apparatus including a processor that is programmed to perform the steps of:
retrieving a request to print the print job;
determining a network availability of one or more other image forming apparatuses connected to the network;
generating a workplan for distributing the print job across a plurality of image forming apparatuses based on (1) print job information, including one or more of: the number of pages, the storage size, and a speed requirement assigned to the print job, and (2) image forming apparatus information, including one or more of: respective loads on, print speeds of, specific capabilities of, and failure rates of the plurality of image forming apparatuses;
dividing, according to the workplan, the print job into a plurality of constituent print jobs, each of which is to be printed by one of the plurality of image forming apparatuses; and
transmitting one of the plurality of constituent print jobs to one of the plurality of image forming apparatuses to be printed thereby.

2. The image forming apparatus of claim 1, wherein the steps further include:
printing another one of the plurality of constituent print jobs.

3. The image forming apparatus of claim 1, wherein the steps further include:
transmitting another one of the plurality of constituent print jobs to another one of the plurality of image forming apparatuses to be printed thereby.

4. The image forming apparatus of claim 1, wherein the steps further include:
generating the workplan with an artificial neural network (ANN) by inputting the print job information and the image forming apparatus information into the ANN, wherein the ANN generates one or more outputs indicating the workplan by performing operations in and between layers of the ANN based on inputs of the print job information and the image forming apparatus information.

5. The image forming apparatus of claim 1, wherein the steps further include:
displaying an option to use parallel printing on a touch screen, and then performing the following steps in response to detecting a selection of parallel printing made via the touch screen:
the dividing of the print job and the transmitting of the one of the plurality of constituent print jobs.

6. The image forming apparatus of claim 1, wherein the steps further include:
determining at least a subset of the image forming apparatus information by transmitting application programming interface (API) requests to one or more of the plurality of image forming apparatuses and then receiving the at least a subset of the image forming apparatus information from the one or more of the plurality of image forming apparatuses.

7. The image forming apparatus of claim 1, wherein the steps further include:
determining to generate the workplan based on one of: the number of pages of the print job being greater than a threshold, the storage size of the print job being greater than a threshold, and the speed requirement assigned to the print job being greater than a threshold.

8. The image forming apparatus of claim 1, wherein the one of the plurality of constituent print jobs includes more pages than another one of the plurality of constituent print jobs, and the steps further include:
assigning, in the workplan, the one of the plurality of constituent print jobs to the one of the plurality of image forming apparatuses based on the one of the plurality of image forming apparatuses having a smaller load than another one of the plurality of image forming apparatuses; and
assigning, in the workplan, the other one of the plurality of constituent print jobs to the other one of the plurality of image forming apparatuses.

9. The image forming apparatus of claim 1, wherein the one of the plurality of constituent print jobs includes more pages than another one of the plurality of constituent print jobs, and the steps further include:
assigning, in the workplan, the one of the plurality of constituent print jobs to the one of the plurality of image forming apparatuses based on the one of the plurality of image forming apparatuses having a higher print speed than another one of the plurality of image forming apparatuses; and
assigning, in the workplan, the other one of the plurality of constituent print jobs to the other one of the plurality of image forming apparatuses.

10. The image forming apparatus of claim 1, wherein the one of the plurality of constituent print jobs includes a specific requirement, which is one of color printing and duplex printing, wherein another one of the plurality of constituent print jobs does not include the specific requirement, and wherein the steps further include:
assigning, in the workplan, the one of the plurality of constituent print jobs to the one of the plurality of image forming apparatuses based on the one of the plurality of image forming apparatuses having a specific capability for performing the specific requirement; and
assigning, in the workplan, the other one of the plurality of constituent print jobs to another one of the plurality of image forming apparatuses that does not have the specific capability.

11. The image forming apparatus of claim 1, wherein the steps further include:
determining not to assign any of the plurality of constituent print jobs to one of the image forming apparatuses connected to the network based on the one of the image forming apparatuses connected to the network having a failure rate that is greater than a threshold.

12. A parallel printing management method for an image forming apparatus connected to a network, to manage parallel printing of a print job, the parallel printing management method comprising:
retrieving a request to print the print job;
determining a network availability of one or more other image forming apparatuses connected to the network;
generating a workplan for distributing the print job across a plurality of image forming apparatuses based on (1) print job information, including one or more of: the number of pages, the storage size, and a speed requirement assigned to the print job, and (2) image forming apparatus information, including one or more of: respective loads on, print speeds of, specific capabilities of, and failure rates of the plurality of image forming apparatuses;
dividing, according to the workplan, the print job into a plurality of constituent print jobs, each of which is to be printed by one of the plurality of image forming apparatuses; and
transmitting one of the plurality of constituent print jobs to one of the plurality of image forming apparatuses to be printed thereby.

13. The parallel printing management method of claim 12, further comprising:
printing another one of the plurality of constituent print jobs.

14. The parallel printing management method of claim 12, further comprising:
transmitting another one of the plurality of constituent print jobs to another one of the plurality of image forming apparatuses to be printed thereby.

15. The parallel printing management method of claim 12, further comprising:
generating the workplan with an artificial neural network (ANN) by inputting the print job information and the image forming apparatus information into the ANN, wherein the ANN generates one or more outputs indicating the workplan by performing operations in and between layers of the ANN based on inputs of the print job information and the image forming apparatus information.

16. The parallel printing management method of claim 12, further comprising:
displaying an option to use parallel printing on a touch screen of the image forming apparatus, and then performing the following steps in response to detecting a selection of parallel printing made via the touch screen: the dividing of the print job and the transmitting of the one of the plurality of constituent print jobs.

17. A non-transitory computer-readable medium comprising instructions that are executable in an image forming apparatus connected to a network, wherein the instructions when executed cause the image forming apparatus to carry out a parallel printing management method to manage parallel printing of a print job, and wherein the parallel printing management method comprises:
retrieving a request to print the print job;
determining a network availability of one or more other image forming apparatuses connected to the network;
generating a workplan for distributing the print job across a plurality of image forming apparatuses based on (1) print job information, including one or more of: the number of pages, the storage size, and a speed requirement assigned to the print job, and (2) image forming apparatus information, including one or more of: respective loads on, print speeds of, specific capabilities of, and failure rates of the plurality of image forming apparatuses;
dividing, according to the workplan, the print job into a plurality of constituent print jobs, each of which is to be printed by one of the plurality of image forming apparatuses; and
transmitting one of the plurality of constituent print jobs to one of the plurality of image forming apparatuses to be printed thereby.

18. The non-transitory computer-readable medium of claim 17, wherein the parallel printing management method further comprises:
determining at least a subset of the image forming apparatus information by transmitting application programming interface (API) requests to one or more of the plurality of image forming apparatuses and then receiving the at least a subset of the image forming apparatus information from the one or more of the plurality of image forming apparatuses.

19. The non-transitory computer-readable medium of claim 17, wherein the parallel printing management method further comprises:
determining to generate the workplan based on one of: the number of pages of the print job being greater than a threshold, the storage size of the print job being greater than a threshold, and the speed requirement assigned to the print job being greater than a threshold.

20. The non-transitory computer-readable medium of claim 17, wherein the one of the plurality of constituent print jobs includes more pages than another one of the plurality of constituent print jobs, and the parallel printing management method further comprises:
assigning, in the workplan, the one of the plurality of constituent print jobs to the one of the plurality of image forming apparatuses based on the one of the plurality of image forming apparatuses having a smaller load than another one of the plurality of image forming apparatuses; and
assigning, in the workplan, the other one of the plurality of constituent print jobs to the other one of the plurality of image forming apparatuses.
